(19) United States
(12) Patent Application Publication
(10) Pub. No.: US 2019/0313090 A1
(43) Pub. Date: Oct. 10, 2019

(54) INTRA PREDICTION MODE DETERMINING DEVICE AND INTRA PREDICTION MODE DETERMINING METHOD

(71) Applicant: MStar Semiconductor, Inc., Hsinchu Hsien (TW)

(72) Inventors: Cheng-Yu HSIEH, Hsinchu Hsien (TW); Chung-Yu CHANG, Hsinchu Hsien (TW)

(21) Appl. No.: 16/140,748

(22) Filed: Sep. 25, 2018

(30) Foreign Application Priority Data
Apr. 9, 2018 (TW) 107112045

(51) Int. Cl. H04N 19/105; H04N 19/159; H04N 19/182

(52) U.S. Cl. CPC H04N 19/105; H04N 19/182; H04N 19/159

(57) ABSTRACT

An intra prediction mode determining device includes: an intra prediction circuit, generating, according to a plurality of prediction modes, a plurality of sets of predicted pixel values of a target prediction unit by using a set of original pixel values of a neighbor prediction unit as a set of adjacent pixel values; a residual calculating circuit, calculating a plurality of residuals based on a set of the original pixel values and the plurality of sets of predicted pixel values of the target prediction unit; and a mode selecting circuit, selecting from the plurality of prediction modes one prediction mode as a candidate mode according to the plurality of sets of residuals.

This application claims the benefit of Taiwan application Serial No. 107112045, filed Apr. 9, 2018, the subject matter of which is incorporated herein by reference.

### BACKGROUND OF THE INVENTION

### Field of the Invention

The invention relates to intra prediction, and more particularly to how to determine an intra prediction mode.

### Description of the Related Art

In the new-generation High Efficiency Video Coding (HEVC) video compression standard, there are 35 intra frame prediction (or simply intra prediction) modes. Therefore, before intra prediction is performed, an appropriate intra prediction mode needs to be first selected.

FIG. 1 shows a block diagram of a conventional intra prediction mode determining device. The intra prediction mode determining device 10 includes a rough mode decision (RDM) circuit 110, an intra prediction circuit 120, a residual calculating circuit 130 and a mode determining circuit 140. The RDM circuit 110 first selects three candidate modes CM1 to CM3 from 35 modes to the intra prediction circuit 120. According to the three candidate modes CM1 to CM3, the intra prediction circuit 120 generates three sets of candidate predicted pixel values CPPV1 to CPPV3 based on a set of neighbor pixel values (NPV) of a target prediction unit to the residual calculating circuit 130. The residual calculating circuit 130 calculates three sets of residuals R1 to R3 on the basis of the three sets of candidate predicted pixel values CPPV1 to CPPV3 to the mode determining circuit 140. The mode determining module 140 then determines, according to the three sets of residual R1 to R3 respectively corresponding to the three candidate modes CM1 to CM3, an intra prediction mode IPM for actually performing intra prediction.

It is known from the above that, the intra prediction circuit 120, the residual calculating circuit 130 and the mode determining circuit 140 cannot perform subsequent operations till the RMD circuit 110 has selected the candidate modes. However, because there are as many as 35 intra prediction modes in the HEVC standard, the operation time of the RMD circuit 110 is long, and this causes an reduced overall compression speed.

### SUMMARY OF THE INVENTION

Therefore, it is an object of the present invention to provide an intra prediction mode determining device and an intra prediction mode determining method for enhancing compression efficiency.

The present invention discloses an intra prediction mode determining device including: an intra prediction circuit, using a set of original pixel values of a neighbor prediction unit as a set of neighbor pixel values to generate a plurality of sets of predicted pixel values of a target prediction unit according to a plurality of prediction modes; a residual calculating circuit, calculating a plurality of sets of residuals based on a set of original pixel values and the plurality of sets of predicted pixel values of the target prediction unit; and a mode selecting circuit, selecting from the plurality of prediction modes one prediction mode as a candidate prediction mode according to the plurality of sets of residuals.

The present invention further discloses an intra prediction mode determining method including: using a set of original pixel values of a neighbor prediction unit as a set of neighbor pixel values to generate a plurality of sets of predicted pixel values of a target prediction unit according to a plurality of prediction modes; calculating a plurality of sets of residuals based on a set of original pixel values and the plurality of sets of predicted pixel values of the target prediction unit; and selecting from the plurality of prediction modes one prediction mode as a candidate prediction mode according to the plurality of sets of residuals.

### BRIEF DESCRIPTION OF THE DRAWINGS

FIG. 1 (prior art) is a block diagram of a conventional intra prediction mode determining device;

FIG. 2 is a block diagram of an intra prediction mode determining device according to an embodiment of the present invention;

FIG. 3 is a flowchart of an intra prediction mode determining method according to an embodiment of the present invention;

FIG. 4 is an exemplary schematic diagram of a target prediction unit and neighbor prediction units;

FIG. 5 is a block diagram of a candidate prediction mode selecting circuit according to an embodiment of the present invention; and

FIG. 6 is a block diagram of an intra prediction mode determining device according to an embodiment of the present invention.

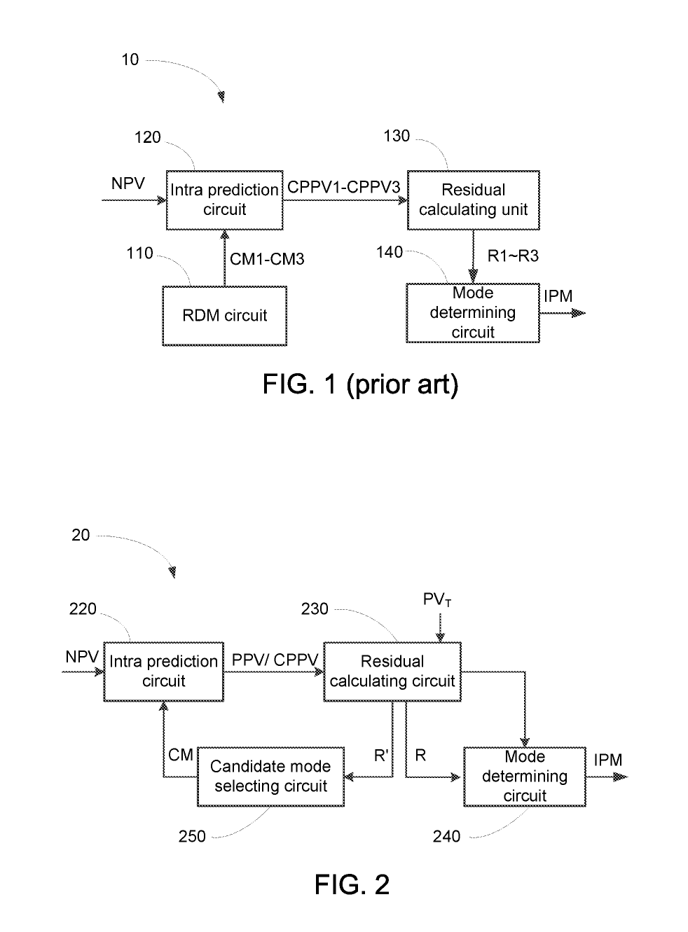

### DETAILED DESCRIPTION OF THE INVENTION

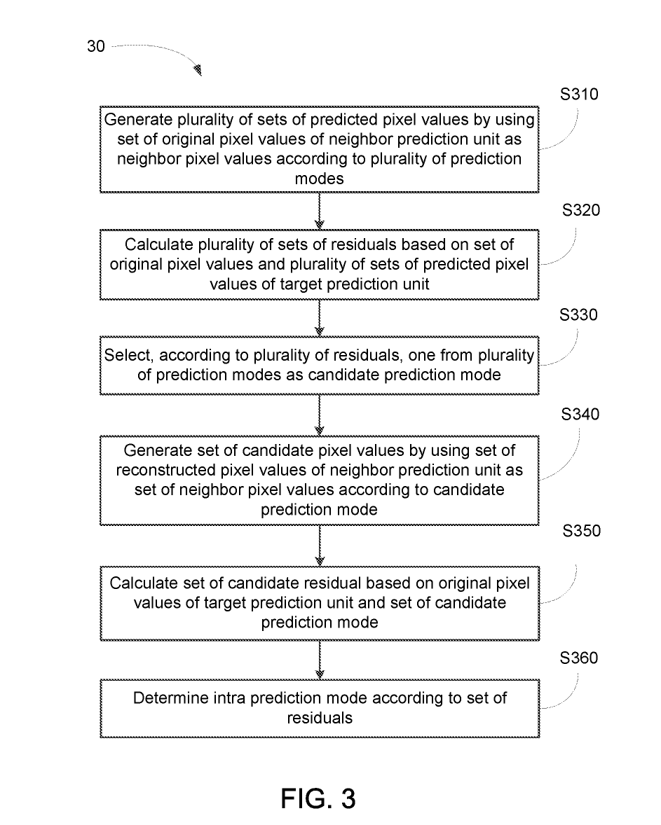

FIG. 2 shows a block diagram of an intra prediction mode determining device 20 according to an embodiment of the present invention. The intra prediction mode determining device 20 includes an intra prediction circuit 220, a residual calculating circuit 230, a mode determining circuit 240 and a candidate mode selecting circuit 250. The intra prediction mode determining device 20 uses the existing intra prediction circuit 220, the residual calculating circuit 230 and the mode determining circuit 240 as well as the additional candidate mode selecting circuit 250 to replace the conventional rough mode decision (RMD) circuit 110, so as to reduce the time needed for determining the candidate mode and thus increasing the compression speed. FIG. 3 shows a flowchart of an intra prediction mode determining method 30 according to an embodiment of the present invention. Refer to FIG. 2 and FIG. 3 together.

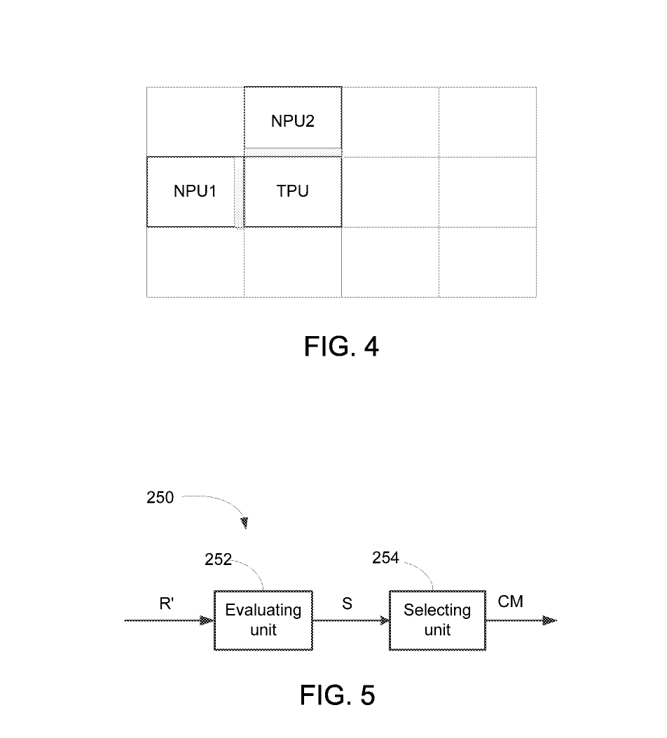

The intra prediction circuit 220 generates a plurality of sets of predicted pixel values PPV of a target prediction unit by using a set of original pixel values PV_{N} of a neighbor prediction unit as a set of neighbor pixel values NPV according to a plurality of prediction modes (step S310). In HEVC, one frame can be divided into multiple prediction units (PU). A PU is a unit for performing intra prediction, and may have dimensions of 4×4, 8×8, 16×16 or 32×32. The PU on which the intra prediction circuit 220 is to perform prediction is referred to as a target prediction unit, and the prediction unit next to the target prediction unit is referred to a neighbor prediction unit. For example, FIG. 4 shows an exemplary schematic diagram of a target prediction unit and neighbor prediction units. As shown in FIG. 4, in one embodiment, the intra prediction circuit 220 uses the original pixel values PV_{N} of the rightmost column in a neighbor prediction unit NPU1 on the left of a target prediction unit TPU and the original pixel values PV_{N} of a lowermost row in a neighbor prediction unit NPU2 above the target prediction unit TPU as a set of neighbor pixel values NPV for performing prediction for the target prediction unit TPU, and generates a set of predicted pixel values PPV of the target prediction unit TPU. It should be noted that, in this embodiment, a neighbor prediction unit is not limited to being on the left or above a target prediction unit. In other embodiments, a neighbor prediction unit may also be located on the right or below a target prediction unit. Further, the present invention is not limited to generating predicted pixel values of a target prediction unit on the basis of original pixel values of two neighbor prediction units. In other embodiments, predicted pixel values may be generated on the basis of original pixel values of more than two neighbor prediction units. For example, predicted pixel values of a target prediction unit may be generated on the basis of original pixel values of a rightmost column of a neighbor prediction unit on the left of the target prediction unit, original pixel values of a lowermost row of a neighbor prediction unit above the target prediction unit, and original pixel values of an uppermost row of a neighbor prediction unit below the target prediction unit.

Further, even if the neighbor pixel values are the same, predicted pixel values generated according to different prediction modes may be different. There are 35 prediction modes in the HEVC standard, and the intra prediction circuit 220 can generate n sets of different predicted pixel values according to n prediction modes among of the 35 prediction modes. To accelerate the overall compression speed, the intra prediction circuit 220 in principle does not generate predicted pixel values according to an overly larger number of prediction modes. In practice, the intra prediction circuit 220 may generate four to ten sets of predicted pixel values according to four to ten prediction modes. For example, the intra prediction circuit 220 may generate five sets of predicted pixel values PPV1 to PPV5 according to five prediction modes PM1 to PM5. Details of how the intra prediction circuit 220 generates a set of predicted pixel values on the basis of a set of neighbor pixel values and according to a prediction mode are conventional techniques, and the associated description is omitted herein.

Next, the residual calculating circuit 230 calculates a plurality of sets of residuals R′ based on a set of original pixel values PV_{T} and the plurality of sets of predicted pixel values PPV of the target prediction unit (step S320). For example, the set of original pixel values of the target prediction unit may be a set of original pixel values PV_{T} of the target prediction unit TPU shown in FIG. 4. In one embodiment, the residual calculating circuit 230 may correspondingly perform subtraction on the set of original pixel values PV_{T} of the target prediction unit TPU and a set of predicted pixel values PPV generated by the intra prediction circuit 220 to calculate a set of residual R′ of the target prediction unit TPU corresponding to a prediction mode. Taking FIG. 4 for example, the residual calculating circuit 230 performs subtraction on the original pixel value PV_{T} corresponding to a position (1, 1) and the predicted pixel value corresponding to the position (1, 1) in the target prediction unit TPU to obtain the residual R1′ corresponding to the position (1, 1). Similarly, by performing subtraction on the original pixel value PT_{V} corresponding to a position (1, 2) and the predicted pixel value PPV₁ corresponding to the position (1, 2) in the target prediction unit TPU, the residual R1′ corresponding to the position (1, 2) can be obtained, and set of residuals R1′ corresponding to the prediction mode PM1 can be then obtained for the target prediction unit TPU. Similarly, the residual calculating circuit 230 can calculate, based on the set of original pixel values PV_{T} of the target prediction unit TPU and the remaining sets of predicted pixel values PPV2 to PPV5, the remaining sets of residuals R2′ to R5′ respectively corresponding to the prediction modes PM2 to PM5.

The candidate mode selecting circuit 250 can select from the plurality of prediction modes PM one prediction mode as a candidate mode CM according to the plurality of sets of residuals R′ (step S330). For example, FIG. 5 shows a block diagram of the candidate mode selecting circuit 250 according to an embodiment of the present invention. Referring to FIG. 5, in one embodiment, the candidate mode selecting circuit 250 includes an evaluating unit 252 and a selecting unit 254. The evaluating unit 252 respectively evaluates a score S of the prediction mode PM according to the plurality of sets of residuals R′. In one embodiment, the evaluating unit 25 may calculate a sum of squares of the set of residuals R1′ as a score S1 corresponding to the prediction mode PM1. In another embodiment, the evaluating unit 252 may calculate the sum of absolute values of the set of residuals R1′ as the score S1 corresponding to the prediction mode PM1. Similarly, the evaluating unit 252 respectively calculates the remaining plurality of scores S2 to S5 corresponding to the prediction modes PM2 to PM5 according to the remaining sets of residuals R2′ to R5′. The selecting unit 254 selects the candidate mode CM from the plurality of prediction modes PM according to the plurality of scores S. In one embodiment, the selecting unit 254 may select the predictions modes PM corresponding to the three smallest scores among the plurality of scores S1 to S5 as the candidate modes CM. For example, assuming that the scores S1 to S5 are respectively 110, 120, 130, 140 and 150, the selecting unit 254 selects the prediction modes PM1 to PM3 corresponding to the scores S1 to S3 as candidate modes CM1 to CM3. It should be noted that, the above scores are exemplary values, and do not represent the actual scores.

Finally, the intra prediction circuit 220 generates a set of candidate predicted pixel values CPPV of the target prediction unit by using a set of reconstructed pixel values RPV_{N} of a neighbor prediction unit as the set of neighbor pixel values NPV according to the candidate mode CM (step S340). The residual calculating circuit 230 calculates a set of candidate residual R based on the set of original pixel values PV_{T} of the target prediction unit and the set of candidate pixel values CPPV (step S350). The mode determining circuit 240 determines an intra prediction mode IPM according to the set of candidate residual R (step S360). For example, the intra prediction circuit 220 may calculate, based on the reconstructed pixel values RPV_{N} of the rightmost column in the neighbor prediction unit NPU1 and the reconstructed pixel values RPV_{N} of the lowermost row in the neighbor prediction unit NPU2, three sets of candidate predicted values CPPV1 to CPPV3 according to the candidate modes CM1 to CM3. The reconstructed pixel values RPV_{N} are reconstructed according to the residuals of the neighbor prediction units NPU1 and NPU2 and the intra prediction mode IPM, and are thus similar to but still slightly differ from the original pixel values PV_{N} of the neighbor prediction units NPU1 and NPU2. It should be noted that, the predicted pixel values PPV of the target prediction unit are calculated based on the original pixel values PV_{N} but not the reconstructed pixel values RPV_{N} of the neighbor prediction units. The reason for the above is that, the intra prediction mode of the neighbor prediction units may yet be undecided when the predicted pixel values PPV of the target prediction unit are calculated, and so the reconstructed pixel values RPV_{N} cannot be generated according to the residuals of the neighbor prediction units and the intra prediction mode IPM at this point. Next, the residual calculating circuit 230 calculates, based on the three sets of candidate predicted pixel values CPPV1 to CPPV3 and the set of original pixel values PV_{T} of the target prediction unit TPU, three sets of residuals R1 to R3 to the mode determining circuit 240, which finally determines, according to the residuals R1 to R3 respectively corresponding to the candidate modes CM1 to CM3, the intra prediction mode IMP actually used for performing intra prediction. It should be noted that, details of steps S340 to S360 are prior art, and the associated description is omitted herein.

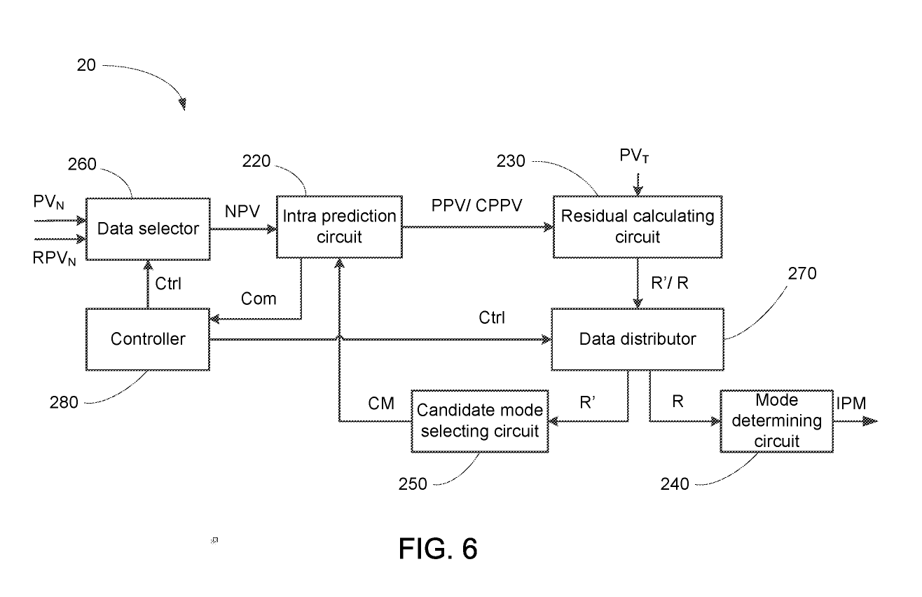

As previously described, when the candidate mode CM is selected, the intra prediction circuit 220 performs prediction based on the original pixel values of the neighbor prediction units; when the intra prediction mode IPM is determined, the intra prediction circuit 220 performs prediction based on the reconstructed pixel values RPV_{N} of the neighbor prediction units. Thus, in one embodiment of the present invention, the input end of the intra prediction circuit 220 is further coupled to a data selector 260. FIG. 6 shows a block diagram of an intra prediction determining device according to an embodiment of the present invention. As shown in FIG. 6, the data selector 260 determines, according to a control signal Ctrl, to output the original pixel values PV_{N} or the reconstructed pixel values RPV_{N} to the intra prediction circuit 220. Further, when the candidate mode CM is selected, the residual calculating circuit 230 outputs the residual R′ to the candidate selecting circuit 250; when the intra prediction mode IPM is determined, the residual calculating circuit 230 outputs the residual to the mode determining circuit 240. Thus, in one embodiment, the input end of the intra prediction circuit 220 is further coupled to a data distributor 270. As shown in FIG. 6, the data distributor 270 determines, according to the control signal Ctrl, to output the residual R′ or R to the candidate mode selecting circuit 250 or the mode determining circuit 240.

In one embodiment, the data selector 260 and the data distributor 270 may be controlled by the same controller; however, the present invention is not limited thereto. For example, the intra prediction mode determining device 20 may further include a controller 280. As shown in FIG. 6, the controller 280 generates a control signal Ctrl according to a completion signal Com outputted from the intra prediction circuit 220. In one embodiment, the controller 280 includes a register for accumulating the number of times of prediction completed by the intra prediction circuit 220. In one embodiment, the data selector 260 first outputs to the intra prediction circuit 220 the original pixel values PV_{N} as the neighbor pixel values NP_{V} for the intra prediction circuit 220 to accordingly perform prediction, and the data distributor 270 outputs to the candidate mode selecting circuit 250 the residual R′ as the reference for selecting the candidate mode CM. When the intra prediction circuit 220 completes the calculation of one set of pixel values, a completion signal Com is sent to the controller 280, which adds the value in the register by one after having received the completion signal Com. In one embodiment, an initial value of the value in the register is 0. When the value reaches a first value, the controller 280 controls the data selector 260 according to the control signal Ctrl to output to the intra prediction circuit 220 the reconstructed pixel values RPV_{N}, as the neighbor pixel values NPV for the intra prediction circuit 220 to accordingly perform prediction; the controller 280 further controls the data distributor 270 to output to the mode determining circuit 240 the residual R, as the reference for determining the intra prediction mode IPM. When the value in the register reaches a second value, the controller 280 resets the value in the register to zero, and controls the data selector 260 according to the control signal Ctrl to output to the intra prediction circuit 220 the original pixel values PV_{N}, as the neighbor pixel values NPV for the intra prediction circuit 220 to accordingly perform prediction; the controller 280 further controls the data distributor 270 to output to the candidate mode selecting circuit 250 the residual R′, as the reference for selecting the candidate mode CM. The first value is determined by the number of sets of predicted pixel values used for selecting the candidate mode. For example, the first value is five when five sets of predicted pixel values are used for selecting three sets of candidate modes. The second value is determined by the number of sets of predicted pixel values used for selecting the candidate mode CM and the number of sets of predicted pixel values used for determining the intra prediction mode IPM. For example, when five sets of predicted pixel values are used for selecting three sets of candidate modes and three sets of predicted pixel values are used for determining the intra prediction mode IPM, the second value is eight, i.e., a sum of the two.

Known from the above, in the present invention, the intra prediction circuit and the residual calculating circuit, during an idle time when the intra prediction circuit and the residual calculating circuit are not used to determine a residual of an intra prediction mode, generate the residual as the reference for selecting the candidate mode. Since the idle time is not long, and an overly large number of sets of residuals for selecting the candidate mode cannot be calculated. Compared to selecting, e.g., three candidate modes from 35 candidate modes by a RMD circuit, the intra prediction mode determining device of the present invention selects, e.g., three candidate modes from five candidate modes, thus significantly reducing the time for determining the candidate mode and enhancing compression speed, as well as enhancing the utilization frequencies of the intra prediction circuit and the residual calculating circuit and hence saving costs of a complicated RMD circuit.

What is claimed is:

1. An intra prediction mode determining device, comprising:
an intra prediction circuit, using a set of original pixel values of a neighbor prediction unit as a set of neighbor pixel values to generate a plurality of sets of predicted pixel values of a target prediction unit according to a plurality of prediction modes;
a residual calculating circuit, calculating a plurality of sets of residuals based on a set of original pixel values and the plurality of sets of predicted pixel values of the target prediction unit; and
a mode selecting circuit, selecting from the plurality of prediction modes one prediction mode as a candidate mode according to the plurality of residuals.

2. The intra prediction mode determining device according to claim 1, wherein the mode selecting circuit comprises:
an evaluating unit, evaluating a plurality of scores respectively corresponding to the plurality of prediction modes according to the plurality of sets of residuals, respectively; and
a selecting unit, selecting the candidate mode from the plurality of prediction modes according to the plurality of scores.

3. The intra prediction mode determining device according to claim 2, wherein each one of the plurality of scores is a sum of squares of each set of the plurality of sets of residuals.

4. The intra prediction mode determining device according to claim 3, wherein the selecting unit selects the prediction mode corresponding to a smallest score among the plurality of scores, as the candidate mode.

5. The intra prediction mode determining device according to claim 1, wherein:
the intra prediction circuit uses a set of reconstructed pixel values of the neighbor prediction unit as the set of neighbor pixel values to generate a set of candidate predicted pixel values of the target prediction unit according to the candidate mode; and
the residual calculating circuit calculates a set of candidate residuals based on the set of original pixel values and the set of candidate predicted pixel values of the target prediction unit;
wherein, the intra prediction mode determining device further comprises:
a mode determining circuit, determining an intra prediction mode according to the set of candidate residuals.

6. An intra prediction mode determining method, comprising:
using a set of original pixel values of a neighbor prediction unit as a set of neighbor pixel values to generate a plurality of sets of predicted pixel values of a target prediction unit according to a plurality of prediction modes;
calculating a plurality of sets of residuals based on a set of original pixel values and the plurality of sets of predicted pixel values of the target prediction unit; and
selecting from the plurality of prediction modes one prediction mode as a candidate mode according to the plurality of residuals.

7. The intra prediction mode determining method according to claim 6, wherein the step of selecting from the plurality of prediction modes one prediction mode as the candidate mode according to the plurality of residuals comprises:
evaluating a plurality of scores respectively corresponding to the plurality of prediction modes according to the plurality of sets of residuals, respectively; and
selecting from the plurality of prediction modes one prediction one as the candidate mode according to the plurality of scores.

8. The intra prediction mode determining method according to claim 7, wherein each one of the plurality of scores are a sum of squares of each set of the plurality of sets of residuals.

9. The intra prediction mode determining method according to claim 8, wherein the step of selecting the candidate mode from the plurality of prediction modes according to the plurality of scores comprises:
selecting the prediction mode corresponding to a smallest score among the plurality of scores, as the candidate mode.

10. The intra prediction mode determining method according to claim 6, further comprising:
using a set of reconstructed pixel values of the neighbor prediction unit as the set of neighbor pixel values to generate a set of candidate predicted pixel values of the target prediction unit according to the candidate mode;
calculating a set of candidate residuals based on the set of original pixel values and the set of candidate predicted pixel values of the target prediction unit; and
determining an intra prediction mode according to the set of candidate residuals.
